(19) United States
(12) Patent Application Publication
(10) Pub. No.: US 2005/0237885 A1
(43) Pub. Date: Oct. 27, 2005

(54) Laser power control method of optical recording/reproducing apparatus

(75) Inventors: Chien-Chun Ma, Hsinchu (TW); Ren-Chien Fu, Hsinchu (TW); Chia-Yuan Pang, Hsinchu (TW)

Correspondence Address: MADSON & METCALF;GATEWAY TOWER WEST, SUITE 900, 15 WEST SOUTH TEMPLE, SALT LAKE CITY, UT, 84101, US

(73) Assignee: Lite-On it Corp.

(21) Appl. No.: 11/107,166

(22) Filed: Apr. 15, 2005

(30) Foreign Application Priority Data
Apr. 22, 2004 (TW) 093111254

(51) Int. Cl. G11B 7/125

(52) U.S. Cl. 369/47.53; 369/47.5; 369/116

(57) ABSTRACT

A method for controlling laser power of an optical recording/reproducing apparatus includes the following steps. Firstly, a writing procedure is performed with an initial electric power level supplied to a laser module of the optical recording/reproducing apparatus. Then, an optimum power calibration (OPC) procedure is performed to determine a first optimum electric power level if a temperature change of the optical recording/reproducing apparatus under the initial electric power level is larger than a threshold value. Afterward, by replacing the initial electric power level with the first optimum electric power level to be supplied to the laser module of the optical recording/reproducing apparatus, the writing procedure is performed.

### FIELD OF THE INVENTION

The present invention relates to a method for controlling laser power, and more particularly to a laser power control method of an optical recording/reproducing apparatus.

### BACKGROUND OF THE INVENTION

Referring to FIG. 1(a), an optical pickup head 1 of an optical recording apparatus is shown. A laser beam emitted from a semiconductor laser module 11 is focused on a disc 2 via lens 14 and 15, and the light reflected by the disc 2 is transmitted to a photo detector 12: to realize information from the disc 2. In general, data are written into the disc 2 by modifying the recording material of the disc 2 with laser beam to leave distinctive marks on the disc. 2. For writing data successfully, power of the laser beam emitted from the semiconductor laser module 11 is generally confined within a critical range. The laser power beyond the operable range would result in inferior data read-back performance or even read-back failure.

Further, depending on the types of discs to be recorded, the laser power applied thereto should be adjusted. For example, the optimum laser power may vary with the recording material of a disc. Recording data into a CD-R disc and recording data into a CD-RW disc also have different optimum laser power levels. Even the tolerable variation of laser power for recording a regular compact disc (CD) is different from that for recording a digital versatile disc (DVD) due to the difference in data intensity. Generally, the power of the laser beam emitted from the semiconductor laser module 11 varies with the electric power inputted thereinto. That is, as the input electric power is increased, the laser power provided for recording data increases, and as the input electric power is decreased, the laser power provided for recording data decreases. For adjusting laser power to fit different types of discs, a so-called optimum power control or optimum power calibration (OPC) means was developed for recording power test.

The test procedure executed with the OPC means is performed at a specific test area on the disc with different laser power levels of the semiconductor laser module 11 before a real recording operation of data. By measuring and comparing the resulting light reflected by the disc and detected by the photo detector 12 corresponding to different power levels with reference information, the electric power input capable of providing the semiconductor laser module 11 with an optimum writing laser power is determined. The process for controlling laser power of the optical pickup head of FIG. 1(a) is illustrated with reference to FIG. 1(b). If a write command is to be executed (S11), a trial-writing OPC procedure is first performed (S12). Then, the real writing procedure is performed with the optimum writing laser power determined in the trial-writing OPC procedure (S13).

In addition to input electric power, working temperature may also influence the laser power of the semiconductor laser module 11. In other words, even if a constant electric power is inputted, the laser power emitted by the semiconductor module 1 is still subject to change with temperature. Generally, the laser power would be decreased when the working temperature is too high or too low beyond the optimum range. Therefore, if the temperature changes significantly after the optimum power laser has been determined according to the optimum power calibration (OPC) test procedure, which is practically common due to environmental condition change or heat resulting from electric-to-photic energy transformation, the previously determined optimum laser power for writing the disc might become improper under the current temperature. If the laser power is not adjusted in response to the temperature variation, writing failure may occur in the subsequently writing operation. For minimizing the influence of the working temperature change on the laser power, a thermal sensor 13 is disposed in the optical pickup head 1 to monitor the temperature change, as can be seen in FIG. 2(a).

The process for controlling laser power of the optical pickup head of FIG. 2(a) is illustrated with reference to FIG. 2(b). If a write command is to be executed (S21), a trial-writing procedure, e.g. an optimum power calibration (OPC) procedure, is first performed (S22). Then, the real writing procedure is performed with the optimum writing laser power determined in the trial-writing OPC procedure (S23). During the writing procedure, the thermal sensor 13 continuously monitors the temperature change within the optical pickup head 1. Once the temperature change measured by the thermal sensor 13 is larger than the threshold value, for example 3° C., during the process of writing the disc (S24), the adjustment of the laser power is done (S25). That is, the electric power inputted into the optical pickup head 1 is adjusted by correlating the temperature detected by the thermal sensor 13 to a look-up table. In this way, the laser power can be maintained at an almost constant level during the writing procedure.

Further, the temperature change of the disc 2 may also influence the writing quality of the disc 2 in another way. It is found that the absorbance of the laser beam is increased as the temperature of the disc 2 is increased. Under this circumstance, for assuring good writing quality, the laser power should be lowered to maintain constant absorbance. Likewise, if the temperature of the disc 2 is decreased, the laser power should be raised. Since a variety of factors may result in the temperature change of the disc 2, the look-up table reflecting the electric power input conditions only is probably not effective enough to adjust the electric power inputted into the optical pickup head 1 accordingly. Currently, there are only look-up tables of a universal type available in view of cost. In other words, it is infeasible for the same look-up table to optimize all the optical pickup heads which are manufactured at different time or in different batches. Therefore, the resulting laser power adjusted according to the look-up table may sometimes be away from the optimum laser power. Particularly, compared with a regular compact disc (CD), the requirement on laser power precision is more critical for a digital versatile disc (DVD). Therefore, the laser power adjustment becomes an even important issue.

### SUMMARY OF THE INVENTION

The present invention provides a method for controlling laser power of an optical recording/reproducing apparatus to adjust the laser power by precisely reflecting the real situation, thereby achieving optimum writing performance.

In accordance with a first aspect of the present invention, there is provided a method for controlling laser power of an optical recording/reproducing apparatus. Firstly, a writing procedure is performed with an initial electric power level supplied to a laser module of the optical recording/reproducing apparatus. Then, an optimum power calibration (OPC) procedure is performed to determine a first optimum electric power level if a temperature change of the optical recording/reproducing apparatus under the initial electric power level is larger than a threshold value. Afterward, by replacing the initial electric power level with the first optimum electric power level to be supplied to the laser module of the optical recording/reproducing apparatus, the writing procedure is performed. The temperature change can be detected by a thermal sensor disposed adjacent to the laser module.

In an embodiment, the method of the present invention further comprises a step of performing a trial-writing procedure before the writing procedure for determining the initial electric power level. Preferably, the trial-writing procedure is another optimum power calibration (OPC) procedure. The optimum power calibration (OPC) procedure comprises steps of writing a test area of the disc with different levels of electric power, reading the test area, and determining the first optimum electric power according to the reading result.

In an embodiment, the different levels of electric power are provided with a previous optimum power level and power levels adjacent to the previous optimum power level.

In an embodiment, the method of the present invention further comprises the following steps. Another optimum power calibration (OPC) procedure is performed to determine a second optimum electric power level if a temperature change of the optical recording/reproducing apparatus under the first optimum electric power level becomes larger than the threshold value. Then, by replacing the first optimum electric power level with the second optimum electric power level to be supplied to the laser module of the optical recording/reproducing apparatus, the writing procedure is performed.

In an embodiment, the method of the present invention further comprises the following steps. A triggering signal is generated at a predetermined time point. Then, another optimum power calibration (OPC) procedure is performed to determine a second optimum electric power level in response to the triggering signal. Then, by replacing the initial electric power level with the second optimum electric power level supplied to the laser module of the optical recording/reproducing apparatus, the writing procedure is performed. Preferably, the triggering signal is asserted at a predetermined interval by a timer.

In accordance with a second aspect of the present invention, there is provided a method for controlling laser power of an optical recording/reproducing apparatus. Firstly, a writing procedure is performed with an initial electric power level supplied to a laser module of the optical recording/reproducing apparatus. Then, a first triggering signal is generated at a first predetermined time point during the writing procedure. Then, an optimum power calibration (OPC) procedure is performed to determine a first optimum electric power level in response to the first triggering signal. Afterward, by replacing the initial electric power level with the first optimum electric power level supplied to the laser module of the optical recording/reproducing apparatus, the writing procedure is performed.

In an embodiment, the method of the present invention further comprises the steps of generating a second triggering signal at a second predetermined time point following the first determined time point at a predetermined interval, performing another optimum power calibration (OPC) procedure to determine a second optimum electric power level in response to the second triggering signal, and performing the writing procedure by replacing the first optimum electric power level with the second optimum electric power level supplied to the laser module of the optical recording/reproducing apparatus.

In an embodiment, the method of the present invention further comprises the steps of performing another optimum power calibration (OPC) procedure to determine a second optimum electric power level if a temperature change of the optical recording/reproducing apparatus under the initial electric power level or the first optimum electric power level is larger than a threshold value, and performing the writing procedure with the second optimum electric power level supplied to the laser module of the optical recording/reproducing apparatus.

Preferably, the disc and the optical recording/reproducing apparatus are digital versatile disc (DVD) and DVD drive, respectively.

The above contents of the present invention will become more readily apparent to those ordinarily skilled in the art after reviewing the following detailed description and accompanying drawings, in which:

### BRIEF DESCRIPTION OF THE DRAWINGS

FIG. 1(a) is a schematic diagram illustrating a typical optical pickup head of a disc recording apparatus;

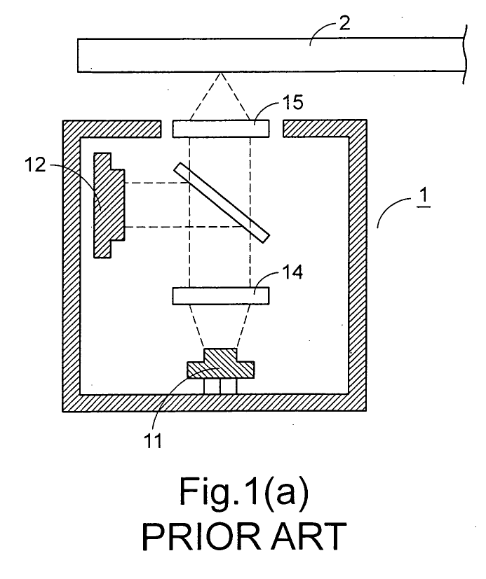

FIG. 1(b) is a flowchart illustrating the process for controlling laser power inputted into the optical pickup head of FIG. 1(a);

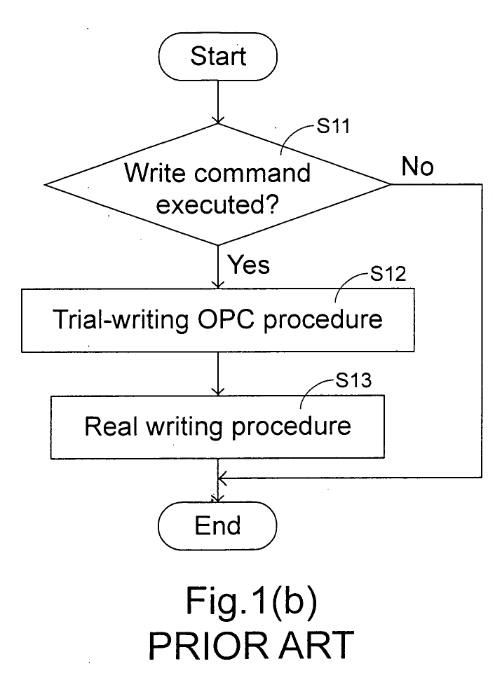

FIG. 2(a) is a schematic diagram illustrating another typical optical pickup head of a disc recording apparatus;

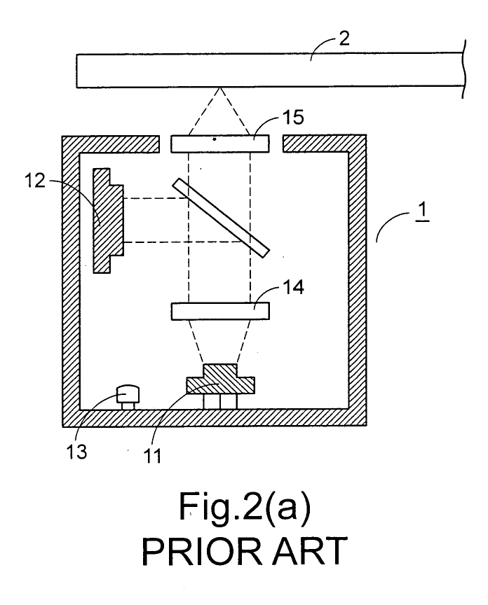

FIG. 2(b) is a flowchart illustrating the process for controlling laser power inputted into the optical pickup head of FIG. 2(a);

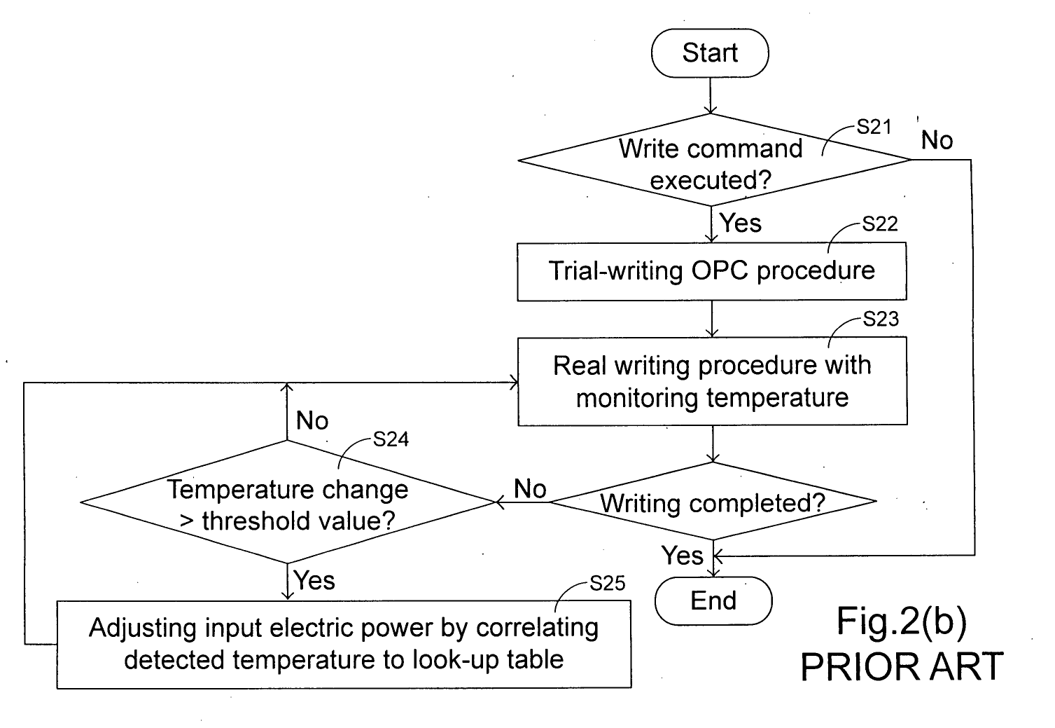

FIG. 3(a) is a schematic diagram illustrating an optical pickup head of an optical drive according to a first embodiment of the present invention;

FIG. 3(b) is a flowchart illustrating the process for controlling laser power inputted into the optical pickup head of FIG. 3(a);

FIG. 4(a) is a schematic diagram illustrating an optical pickup head of an optical drive according to a second embodiment of the present invention;

FIG. 4(b) is a flowchart illustrating the process for controlling laser power inputted into the optical pickup head of FIG. 4(a);

FIG. 5(a) is a schematic diagram illustrating an optical pickup head of an optical drive according to a third embodiment of the present invention; and

FIG. 5(b) is a flowchart illustrating the process for controlling laser power inputted into the optical pickup head of FIG. 5(a).

### DETAILED DESCRIPTION OF THE PREFERRED EMBODIMENT

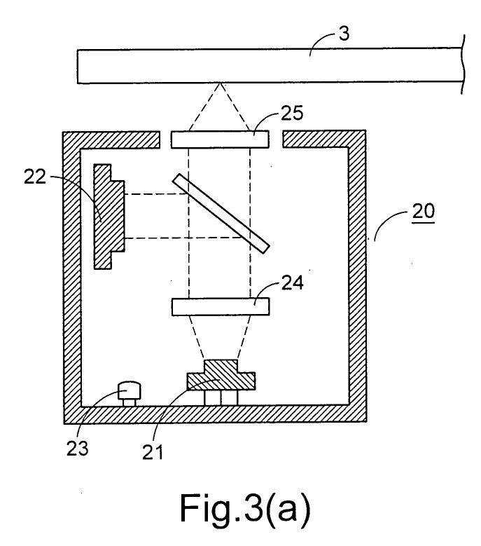

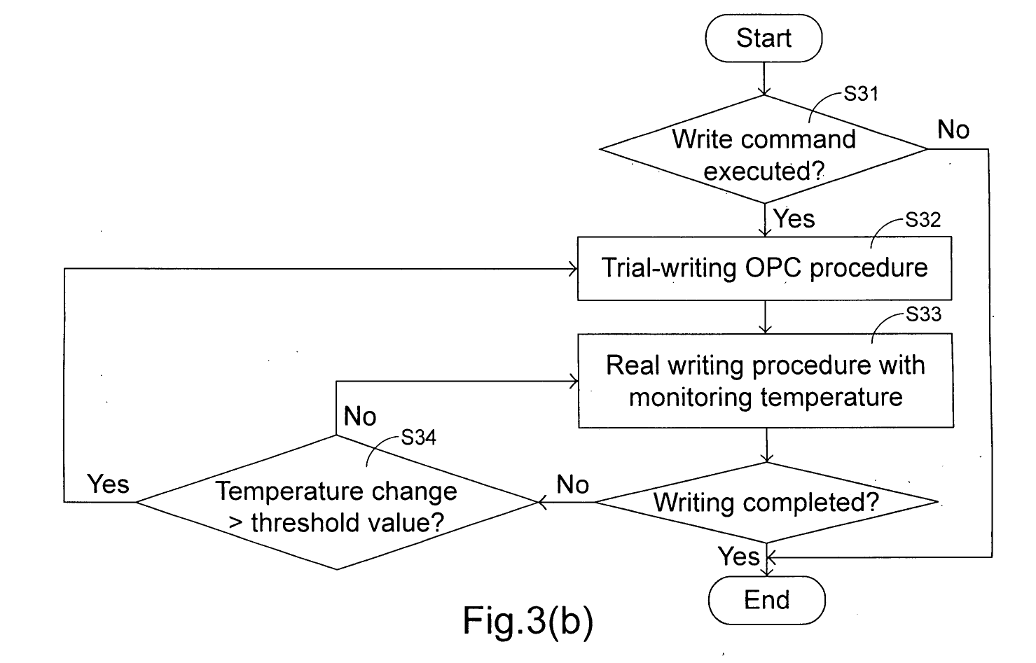

Referring to FIG. 3(a), an optical pickup head 20 of an optical drive according to an embodiment of the present invention is illustrated. The optical pickup head 20 comprises a semiconductor laser module 21, a photo detector 22, a thermal sensor 23 and lens 24 and 25. For writing data into a disc 3, laser beam emitted from the semiconductor laser module 21 is focused on the disc 3 via the lens 24 and 25, and the light reflected by the disc 3 is transmitted to the photo detector 22 to reproduce information from the disc 3.

For assuring a satisfactory quality of a writing operation (Step 31), the laser power of the optical pickup head should be well controlled at an optimum level. In order to achieve this purpose, a trial-writing procedure, e.g. an optimum power calibration (OPC) procedure, is performed beforehand (S32). The optimum power calibration (OPC) procedure is performed at a specific test area on the disc 3 with different laser power levels of the semiconductor laser module 31. By reading the resulting data from the test area on the disc 3 respectively under the different power levels and comparing them with reference information, an optimum initial electric power level is determined. After the optimum power calibration (OPC) procedure, a real writing procedure is performed with the initial electric power level supplied to the laser module 31 (S33). During the writing procedure, the thermal sensor 23 continuously monitors the temperature change within the optical pickup head 20 to see if the temperature changes significantly (S34). If the temperature change measured by the thermal sensor 23 is larger than a threshold value, for example 3° C., the adjustment of the laser power is done by performing the trial-writing optimum power calibration (OPC) procedure of Step 32 again, which determines a new optimum electric power level. Then, the real writing procedure is performed with the new optimum electric power level which replaces the initial electric power level to be supplied to the laser module 23 (S33). Meanwhile, the temperature change is still monitored and the power level adjustment is still performed until the writing operation is completed. It should be understood the acceptable temperature change varies with practical requirements. In general, it is proper to be set within 3˜5° C.

Since the electric power inputted into the optical pickup head 20 is adjusted provided that the temperature change is beyond an acceptable range, the method of the present invention can precisely reflecting the real situation of the optical pickup head, thereby achieving optimum writing performance.

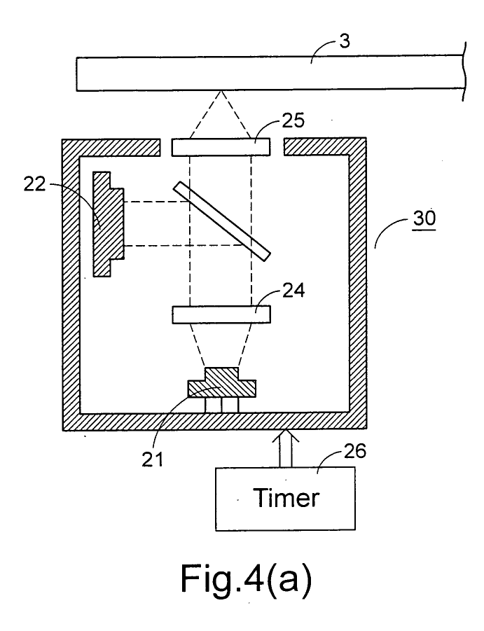

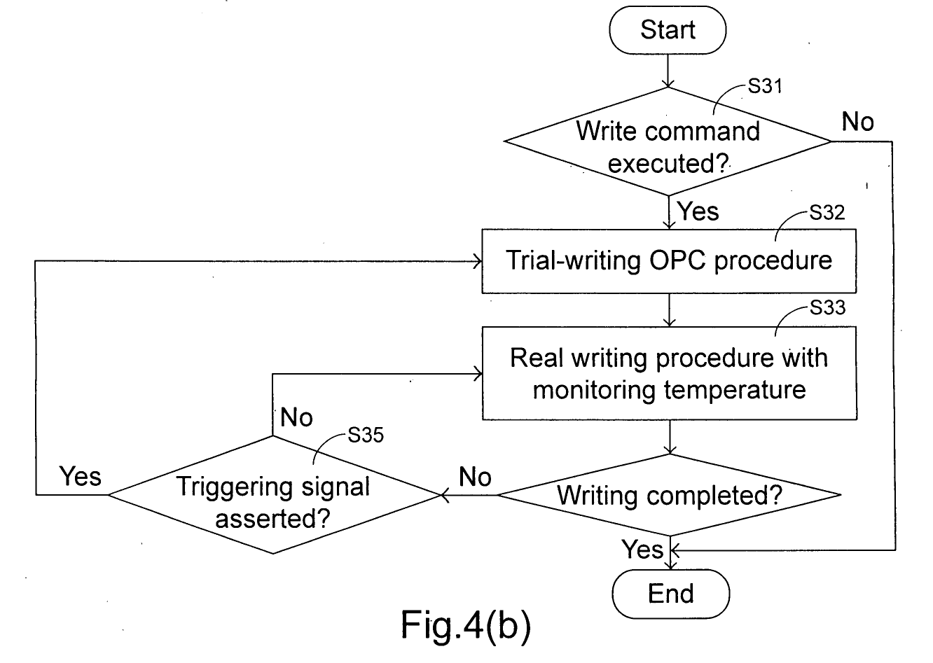

Another embodiment of an optical pickup head is illustrated in FIG. 4(a). In this embodiment, the semiconductor laser module 21, the photo detector 22 and lens 24 and 25 included in the optical pickup head 30 are similar to those shown in FIG. 3(a), and are not to be redundantly described herein. In this embodiment, a timer 26 is used to count time while a writing operation is performed. The process for controlling laser power by using the timer 26 will be illustrated herein with reference to the flowchart of FIG. 4(b). The steps S31, S32 and S33 are similar to those shown in FIG. 3(a). However, in this embodiment, the timer 26 asserts a triggering signal at a predetermined time point, for example asserts triggering signals periodically at an interval of 20˜30 minutes, instead of monitoring temperature change, for adjusting the electric power level (S35). Upon a triggering signal is asserted by the timer 26, the adjustment of the laser power is done by performing the trial-writing optimum power calibration (OPC) procedure of Step 32 again to determine a new optimum electric power level. Accordingly, the writing procedure of Step 33 can be performed with the optimum electric power level supplied to the laser module 23. The steps S32 and S33 will be repeated until no triggering signal is asserted or the writing operation is completed. In such a manner, the optimum electric power level can be periodically adjusted, so optimum writing performance can be achieved. It should be understood the interval for asserting the triggering signal varies with practical requirements. In general, it is proper to be set within 20˜30 minutes.

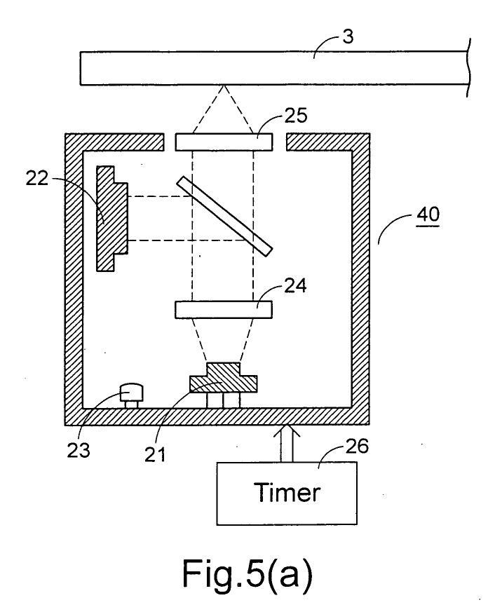

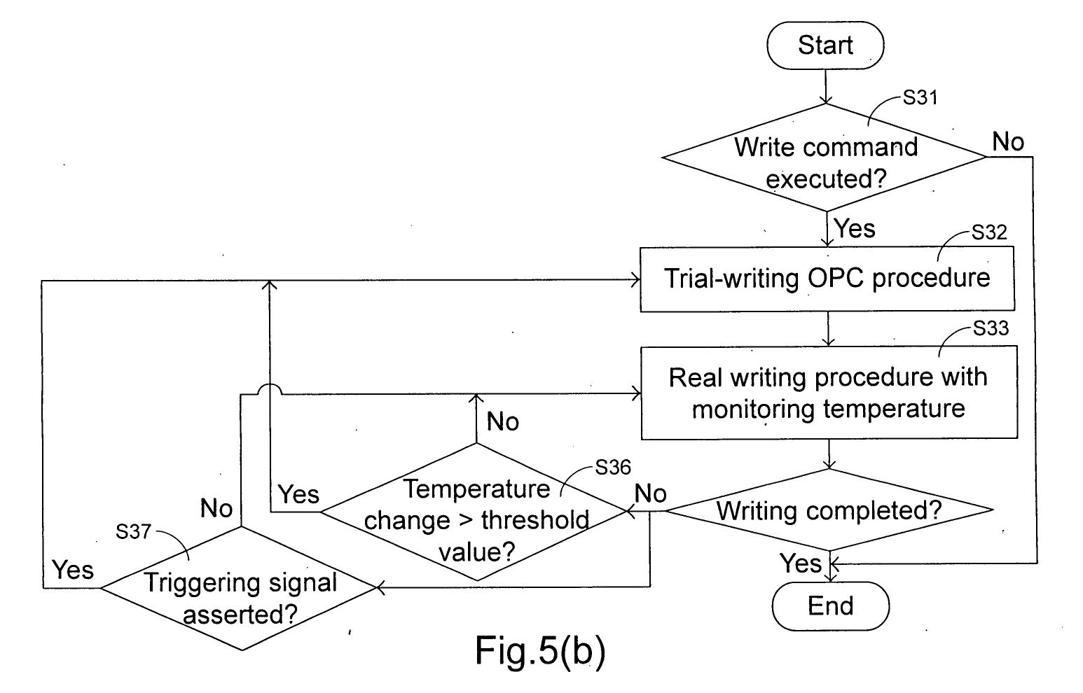

A further embodiment of an optical pickup head is illustrated in FIG. 5(a). In this embodiment, the optical pickup head 40 comprises a semiconductor laser module 21, a photo detector 22, a thermal sensor 23, lens 24 and 25, and a timer 26. The process for controlling laser power by using the thermal sensor 23 and the timer 26 is illustrated with reference to the flowchart of FIG. 5(b). The steps S31, S32 and S33 are similar to those shown in FIG. 3(a). During the writing procedure, the thermal sensor 23 continuously monitors the temperature change within the optical pickup head 40, and at the same time, the timer 26 asserts triggering signals periodically at a predetermined time interval. In one hand, if the temperature change measured by the thermal sensor 23 is larger than a threshold value during the process of writing the disc (S36), the adjustment of the laser power will be done by supplying a new optimum electric power level to the laser module 21. On the other hand, the adjustment of the laser power will also be done to supply a new optimum electric power level to the laser module 21 if a triggering signal is asserted by the timer 26 during the process of writing the disc (S37). The new optimum electric power level is realized by executing the optimum power calibration (OPC) procedure of Step 32 again, and the real writing procedure will be performed by replacing the initial electric power level with the new optimum electric power level, which is rendered due to either temperature change or periodical adjustment. Every new optimum power calibration (OPC) procedure can be performed even more efficiently by providing trial-writing laser power levels with previous optimum power level and power levels adjacent to it. Besides, the timer 26 can be reset whenever a new optimum electric power level is obtained with the trial-writing OPC procedure or whenever the real writing procedure starts with the new optimum electric power level. The steps S32 and S33 are preferably repeated until the writing operation is completed.

From the above description, it is understood that the method for controlling laser power of an optical recording/reproducing apparatus according to the present invention is advantageous because of adjusting the laser power by precisely reflecting the real situation. Therefore, optimum writing performance can be achieved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A method for controlling laser power of an optical recording/reproducing apparatus, comprising steps of:
performing a writing procedure with an initial electric power level supplied to a laser module of said optical recording/reproducing apparatus;
performing an optimum power calibration (OPC) procedure to determine a first optimum electric power level if a temperature change of said optical recording/reproducing apparatus under said initial electric power level is larger than a threshold value; and
performing said writing procedure by replacing said initial electric power level with said first optimum electric power level to be supplied to said laser module of said optical recording/reproducing apparatus.

2. The method according to claim 1 further comprising a step of performing a trial-burning procedure before said writing procedure for determining said initial electric power level.

3. The method according to claim 2 wherein said trial-writing procedure is another optimum power calibration (OPC) procedure.

4. The method according to claim 1 wherein said optimum power calibration (OPC) procedure comprises steps of:
writing a test area of said disc by providing said laser module with different levels of electric power;
reading said test area; and
determining an optimum electric power according to the reading result.

5. The method according to claim 4 wherein said different levels of electric power are provided with a previous optimum power level and power levels adjacent to said previous optimum power level.

6. The method according to claim 1 wherein said temperature change is detected by a thermal sensor disposed adjacent to said laser module.

7. The method according to claim 1 further comprising steps of:
performing another optimum power calibration (OPC) procedure to determine a second optimum electric power level if a temperature change of said optical recording/reproducing apparatus under said first optimum electric power level becomes larger than said threshold value; and
performing said writing procedure by replacing said first optimum electric power level with said second optimum electric power level to be supplied to said laser module of said optical recording/reproducing apparatus.

8. The method according to claim 1 further comprising steps of:
generating a triggering signal at a predetermined time point;
performing another optimum power calibration (OPC) procedure to determine a second optimum electric power level in response to said triggering signal; and
performing said writing procedure by replacing said initial electric power level with said second optimum electric power level supplied to said laser module of said optical recording/reproducing apparatus.

9. The method according to claim 8 wherein said triggering signal is asserted at a predetermined interval by a timer.

10. The method according to claim 1 wherein said disc and said optical recording/reproducing apparatus are digital versatile disc (DVD) and DVD drive, respectively.

11. A method for controlling laser power of an optical recording/reproducing apparatus, comprising steps of:
performing a writing procedure with an initial electric power level supplied to a laser module of said optical recording/reproducing apparatus;
generating a first triggering signal at a first predetermined time point during said writing procedure;
performing an optimum power calibration (OPC) procedure to determine a first optimum electric power level in response to said first triggering signal; and
performing said writing procedure by replacing said initial electric power level with said first optimum electric power level supplied to said laser module of said optical recording/reproducing apparatus.

12. The method according to claim 11 further comprising steps of:
generating a second triggering signal at a second predetermined time point following said first determined time point at a predetermined interval;
performing another optimum power calibration (OPC) procedure to determine a second optimum electric power level in response to said second triggering signal; and
performing said writing procedure by replacing said first optimum electric power level with said second optimum electric power level supplied to said laser module of said optical recording/reproducing apparatus.

13. The method according to claim 11 wherein each of said first and second triggering signals is asserted at a predetermined interval by a timer.

14. The method according to claim 11 further comprising steps of:
performing another optimum power calibration (OPC) procedure to determine a second optimum electric power level if a temperature change of said optical recording/reproducing apparatus under said initial electric power level or said first optimum electric power level is larger than a threshold value; and
performing said writing procedure with said second optimum electric power level supplied to said laser module of said optical recording/reproducing apparatus.

15. The method according to claim 11 further comprising a step of performing a trial-writing procedure before said writing procedure for determining said initial electric power level.

16. The method according to claim 15 wherein said trial-writing procedure is another optimum power calibration (OPC) procedure.

17. The method according to claim 11 wherein said optimum power calibration (OPC) procedure comprises steps of:
writing a test area of said disc with different levels of electric power;
reading said test area; and
determining an optimum electric power according to the reading result.

18. The method according to claim 17 wherein said different levels of electric power are provided with a previous optimum power level and power levels adjacent to said previous optimum power level.

19. A method for controlling laser power of an optical recording/reproducing apparatus, comprising steps of:
performing a first writing procedure with an initial electric power level supplied to a laser module of said optical recording/reproducing apparatus;
performing an optimum power calibration (OPC) procedure to determine a first optimum electric power level if a temperature change of said optical recording/reproducing apparatus under said initial electric power level is larger than a threshold value;
generating a triggering signal at a predetermined time point;
performing another optimum power calibration (OPC) procedure to determine a second optimum electric power level in response to said triggering signal; and
performing said writing procedure by replacing said initial electric power level with said first or second optimum electric power level, whichever occurs earlier, and supplying the new optimum electric power level to said laser module of said optical recording/reproducing apparatus.
